(19) United States
(12) Patent Application Publication
(10) Pub. No.: US 2025/0092579 A1
(43) Pub. Date: Mar. 20, 2025

(54) CONDUCTIVE POROUS MATERIAL AND ELECTRODE USING SAME, AND METHOD FOR PRODUCING CONDUCTIVE POROUS MATERIAL

(71) Applicant: Panasonic Intellectual Property Management Co., Ltd., Osaka (JP)

(72) Inventors: KAZUMA OIKAWA, Osaka (JP); RYOU KUWABARA, Osaka (JP)

(21) Appl. No.: 18/964,623

(22) Filed: Dec. 1, 2024

Related U.S. Application Data
(63) Continuation of application No. PCT/JP2023/016232, filed on Apr. 25, 2023.

(30) Foreign Application Priority Data
Jun. 15, 2022 (JP) 2022-096796
Nov. 8, 2022 (JP) 2022-179012

(51) Int. Cl. D01F 9/17; C01B 32/184

(52) U.S. Cl. CPC D01F 9/17; C01B 32/184; C01P 2002/89; C01P 2004/03; C01P 2006/40

(57) ABSTRACT

A conductive porous material includes a skeleton structure containing a fibrous carbonaceous material of biological origin, and graphene held by the skeleton structure. A volume resistivity of the conductive porous material measured under pressure of less than or equal to 10 MPa is 1.0×10⁻³ to 1.0×10⁰ Ω·cm. A biomass degree of the conductive porous material, as measured by accelerator mass spectrometry (AMS) method, is in a range of 5 to 55 pMC. An electrode includes the conductive porous material.

### TECHNICAL FIELD

The present invention relates to a conductive porous material, an electrode using the same, and a method for producing a conductive porous material.

### BACKGROUND ART

In order to realize a decarbonized society, it is strongly required to improve the performance of power storage devices such as a lithium ion battery and an electric double layer capacitor, and power generation devices such as a fuel cell and a solar cell. In any device, improvement of an electrode material is effective as one method for improving performance. In order to improve the electrical characteristics of the electrode material, it is important to improve the conductivity of the electrode material and to increase the specific surface area of the electrode material.

Graphene has a high specific surface area of 2630 m²/g and high conductivity, and thus has attracted attention as a new electrode material to replace the current activated carbon electrode (NPL 1 and NPL 2). For example, the electric capacity of the chemically modified graphene (CMG) is 135 F/g in the measurement in an aqueous electrolytic solution and 99 F/g in the measurement in an organic electrolytic solution (NPL 2), which is 3 times or more higher than the electric capacity of the activated carbon electrode (about 30 to 40 F/g).

As a method for producing an electrode material containing graphene, there is a method in which graphite is subjected to an oxidation treatment to obtain graphite oxide, and the graphite oxide is dispersed in a solvent and exfoliated in layers to obtain graphene oxide (PTL 1, NPL 2 to NPL 4). After the graphene oxide is formed into a desired shape such as a thin film, the graphene oxide is subjected to a reduction treatment to obtain a graphene-containing electrode material.

For the oxidation treatment of graphite, a strong oxidizing agent such as potassium permanganate, and concentrated sulfuric acid are used (PTL 1 and NPL 2).

### CITATION LIST

### Patent Literature

PTL 1: Unexamined Japanese Patent Publication No. 2012-31024

### Non-Patent Literature

NPL 1: Xia j. L., et al., Nat. Nanotechnol., 4 (2009) 505-509.
NPL 2: Stoller M. D., et al., Nano Lett., 8 (2008) 3498-3502.
NPL 3: Hummers W. S., et al., J. Am. Chem. Soc., 80 (1958) 1339.
NPL 4: Wen Z., et al., Adv. Mater., 24 (2012) 5610-5616.

### SUMMARY OF THE INVENTION

A conductive porous material according to an aspect of the present invention includes:
a skeleton structure containing a fibrous carbonaceous material of biological origin; and graphene held by the skeleton structure,
in which a volume resistivity of the conductive porous material measured under pressure of less than or equal to 10 MPa is 1.0×10⁻³ to 1.0×10² Ω·cm, and
a biomass degree of the conductive porous material, as measured by accelerator mass spectrometry (AMS) method, is in a range of 5 to 55 pMC.

### BRIEF DESCRIPTION OF THE DRAWINGS

FIG. 1A is a schematic diagram for explaining a method for producing a conductive porous material according to an exemplary embodiment of the present invention.

FIG. 1B is a schematic diagram for explaining the method for producing the conductive porous material according to the exemplary embodiment of the present invention.

FIG. 1C is a schematic diagram for explaining the method for producing the conductive porous material according to the exemplary embodiment of the present invention.

FIG. 1D is a schematic diagram for explaining the method for producing the conductive porous material according to the exemplary embodiment of the present invention.

FIG. 2 is an appearance photograph of a conductive porous material of Example 1.

FIG. 3 is an SEM image of the conductive porous material of Example 1.

FIG. 4 is an SEM image of a conductive porous material of Example 2.

FIG. 5 is an SEM image of a conductive porous material of Example 3.

FIG. 6 is an SEM image of a conductive porous material of Example 4.

FIG. 7 is an SEM image of a conductive porous material of Example 5.

FIG. 8 is an SEM image of a conductive porous material of Example 6.

FIG. 9 is an SEM image of a conductive porous material of Example 7.

FIG. 10 is an appearance photograph of a graphite powder of Comparative Example 1.

FIG. 11 is an SEM image of a graphite powder of Comparative Example 1.

FIG. 12 is a graph illustrating pressure dependence of volume resistivity of a conductive porous material.

FIG. 13 is a graph illustrating a relationship between a cellulose nanofiber weight ratio of a conductive porous material (before firing) and a biomass degree of a conductive porous material (fired body).

### DESCRIPTION OF EMBODIMENT

Graphene having a flat scale shape is prone to layering and agglomeration due to van der Waals force. For example, even when graphene is forcibly dispersed in a dispersion medium, the graphene is easily re-aggregated. Therefore, when a specific surface area of an electrode material containing graphene is actually measured, the specific surface area may be significantly lower than the theoretical value.

In a case where the electrode material is produced using graphene oxide as disclosed in PTL 1 and NPL 2 to NPL 4, the graphene oxide has a large number of oxygen functional groups such as a hydroxyl group and a carboxyl group on the surface, and thus is excellent in dispersibility in a dispersion medium. However, since the graphene oxide is finally subjected to the reduction treatment to remove the oxygen functional group, the reduced graphene is re-aggregated, and the specific surface area also decreases.

Therefore, in a case where an electrode material is formed using graphene, it is important to suppress re-aggregation of the graphene.

Furthermore, since highly toxic substances such as potassium permanganate and concentrated sulfuric acid is used in the oxidation treatment for obtaining the graphene oxide, the manufacturing cost of the graphene increases, and there is a risk that it is dangerous in mass production. Therefore, a novel method for producing a graphene-containing electrode material without performing an oxidation treatment is required.

In a method in which a graphene source such as graphite is physically exfoliated under wet conditions to obtain a graphene dispersion liquid, the specific surface area of graphene increases with the exfoliation of graphite and the production of graphene, and the viscosity of the dispersion liquid rapidly increases. Therefore, the exfoliation efficiency of graphite is reduced, and the dispersibility of graphene in the dispersion liquid is reduced.

The present inventors have found that graphene interaction can be reduced by adding a fibrous carbon source (biomass fiber) of biological origin to the graphene dispersion liquid in advance and allowing the fibrous carbon source and graphene to coexist. By the fibrous carbon source, thickening of the graphene dispersion liquid can be suppressed, and a graphene dispersion liquid having high dispersibility can be obtained.

A composite obtained by drying the dispersion liquid is fired at a high temperature to carbonize the fibrous carbon source, whereby a skeleton structure containing fibrous carbonaceous material can be formed. Then, a conductive porous material in which graphene is held in the skeleton structure is obtained.

Furthermore, in a method for producing a conductive porous material according to an aspect of the present invention, when preparing a graphene dispersion liquid, energy is externally applied to a mixed solution obtained by mixing a graphene source, a dispersion medium, and a fibrous carbon source of biological origin. As a result, the graphene source is physically exfoliated to produce graphene. Since graphene is stabilized in a state of being in contact with the fibrous carbon source, a dispersed state of graphene is maintained, and re-aggregation is suppressed. As described above, a graphene dispersion liquid having excellent dispersibility can be obtained.

According to the method for producing a conductive porous material according to an aspect of the present invention, since it is not necessary to chemically treat the graphene source, production efficiency is high and utility value is industrially high.

Note that a graphene manufacturing process by a chemical vapor deposition (CVD) method also does not require an oxidation treatment of graphene, but the productivity of graphene is low and the manufacturing cost is high.

One object of the present invention is to provide a conductive porous material in which re-aggregation of graphene is suppressed and an electrode including the same.

Another object of the present invention is to provide a method for producing the conductive porous material according to the present invention without oxidizing graphene.

A first aspect of the present invention is
a conductive porous material including: a skeleton structure containing a fibrous carbonaceous material of biological origin; and graphene held by the skeleton structure,
in which a volume resistivity of the conductive porous material measured under pressure of less than or equal to 10 MPa is 1.0×10⁻³ to 1.0×10² Ω·cm, and
a biomass degree of the conductive porous material, as measured by accelerator mass spectrometry (AMS) method, is in a range of 5 to 55 pMC.

A second aspect of the present invention is
the conductive porous material according to the first aspect, in which the skeleton structure has carbon atoms more than or equal to 80 atom % of an entire skeleton structure.

A third aspect of the present invention is
the conductive porous material according to the first aspect or the second aspect, in which the skeleton structure includes a fired body obtained by firing one or more fibrous carbon sources selected from the group consisting of cellulose, chitin, chitosan, lignin, and tannin.

A fourth aspect of the present invention is
an electrode including the conductive porous material according to any one of the first aspect to the third aspect.

A fifth aspect of the present invention is
a method for producing a conductive porous material according to any one of the first aspect to the third aspect, the method including:
(1) mixing a dispersion medium, a graphene source, and a fibrous carbon source of biological origin, and applying external energy to prepare a dispersion liquid containing the dispersion medium, graphene, and the fibrous carbon source;
(2) removing the dispersion medium from the dispersion liquid to create a composite containing the graphene and the fibrous carbon source; and
(3) firing the composite to obtain the conductive porous material.

A sixth aspect of the present invention is
the method for producing a conductive porous material according to the fifth aspect, in which the fibrous carbon source is one or more selected from the group consisting of cellulose, chitin, chitosan, lignin, and tannin.

A seventh aspect of the present invention is
the method for producing a conductive porous material according to the fifth aspect or the sixth aspect, in which the graphene source is one or more selected from the group consisting of artificial graphite, natural graphite, and multilayered graphene.

An eighth aspect of the present invention is
the method for producing a conductive porous material according to any one of the fifth aspect to the seventh aspect, in which the dispersion medium is water.

According to an exemplary embodiment of the present invention, it is possible to provide a conductive porous material in which re-aggregation of graphene is suppressed and an electrode including the conductive porous material.

According to another exemplary embodiment of the present invention, a method for producing a conductive porous material without oxidizing graphene can be provided.

Next, preferred exemplary embodiments of the present invention will be described.

### <Conductive Porous Material>

A conductive porous material according to an exemplary embodiment of the present invention includes a skeleton structure of a fibrous carbonaceous material of biological origin and graphene held by the skeleton structure. The skeleton structure suppresses aggregation of graphene. Therefore, a conductive porous material having a large specific surface area is obtained.

It can be confirmed by radioactive carbon ¹⁴C measurement that the fibrous carbonaceous material contained in the skeleton structure is biologically derived. The radioactive carbon ¹⁴C can be analyzed by using, for example, accelerator mass spectrometry (AMS). Note that, in the AMS method, since it is not necessary to wait for ¹⁴C to collapse, the measurement can be performed in a short time, and the measurement can be performed in about 1 hour per sample. Moreover, since the AMS method directly measures the number of ¹⁴C present in a large amount in a sample, it can be measured in an amount of about 1/1000 as compared with an amount of sample used in the β ray counting method. By the AMS method, it is possible to measure samples that are desired to minimize destruction, such as samples that could only be collected in extremely small amounts and valuable cultural properties, and the AMS method is utilized in various fields.

One of the features of ¹⁴C is a radioisotope, which has the property of radiative decay to nitrogen (¹⁴N) with a half-life of 5730 years. On earth, an extremely small amount of ¹⁴C is continuously generated by the action of cosmic rays falling from space. The generated ¹⁴C is oxidized to carbon dioxide ¹⁴CO₂, diffuses into the atmosphere, is then incorporated into plants/animals in the process of a food chain, and disappears according to a half-life while circulating in the environment via the food chain. Age measurement is performed using this phenomenon. On the other hand, human activities after the industrial revolution fluctuate the natural ¹⁴C cycle. The use of fossil fuels (called dead C) such as oil and coal without ¹⁴C decreased the apparent ¹⁴C concentration, while the atmospheric ¹⁴C concentration rapidly increased due to the formation of ¹⁴C (Bomb C) associated with atmospheric nuclear experiments performed for about 10 years since the 1950s. As a result, carbon derived from living organisms that have existed since 1950 is called modern carbon (modern C), and contains ¹⁴C that is thousands of times more than fossil fuels.

Modern carbon of biological origin is said to have a ¹⁴C/¹²C ratio of approximately 1.2×10⁻¹², and fossil fuel-derived carbon dead C is said to have a ¹⁴C/¹²C ratio of less than or equal to 1.0×10⁻¹⁶. By utilizing this finding, it is possible to determine whether or not the fibrous carbonaceous material contained in the skeleton structure is biologically derived.

### (Biomass Degree of Conductive Porous Material)

A content rate of the biologically derived resources (biomass) contained in the measurement sample can be represented by an index “biomass degree”. The biomass degree is specified in ASTM D6866-22, and can be calculated from the concentration of biologically derived carbon (¹⁴C). The unit of the biomass degree is percent modern carbon (pMC). In a case where the measurement sample is produced from a 100% biologically derived substance, the biomass degree is approximately 100 pMC, and in a case where the measurement sample is produced from a 100% fossil fuel derived substance, the biomass degree is approximately 0 pMC.

If the fibrous carbonaceous material constituting the conductive porous material is biologically derived, the biomass degree of the conductive porous material can be determined by measuring the concentration of the radioactive carbon ¹⁴C in the conductive porous material using the above-described AMS method. This makes it possible to quantify the concentration of biologically derived carbon contained in the conductive porous material.

The biomass degree of the conductive porous material is preferably 5 to 55 pMC and more preferably 10 to 30 pMC in the case of being measured by the AMS method.

### (Volume Resistivity of Conductive Porous Material)

Volume resistivity of the conductive porous material can vary depending on the magnitude of a load applied to the material at the time of measurement, and thus cannot be said unconditionally, but is preferably less than or equal to 1.0×10² Ω·cm, and more preferably less than or equal to 1.0×10⁻¹ Ω·cm.

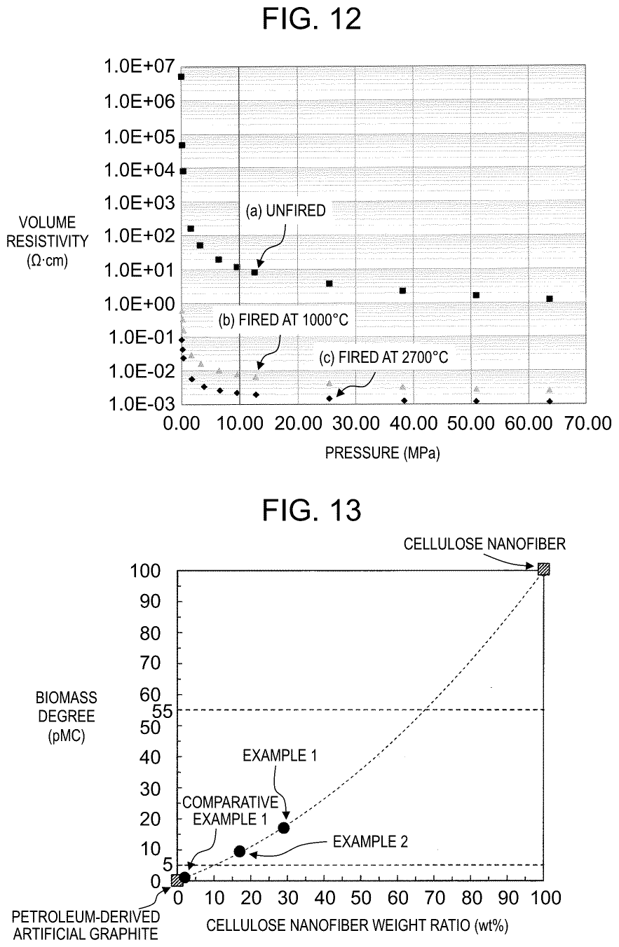

Here, a relationship between the volume resistivity of the conductive porous material and the load (pressure) applied to the material was examined. FIG. 12 is a graph illustrating results of measuring the volume resistivity of the conductive porous material in a range of 0.1 MPa to 64 MPa while changing the pressure. The samples for measuring the volume resistivity are a cryogel of a graphene-cellulose composite prepared in Example 1 described later (the graph “(a) unfired” in FIG. 12), a conductive porous material obtained by firing the cryogel at 1000° C. for 1 minute (the graph “(b) fired at 1000° C.” in FIG. 12), and a conductive porous material obtained by firing the cryogel at 2700° C. for 1 minute (the graph “(c) fired at 2700° C.” in FIG. 12).

Since in the graph (a), the sample is the unfired cryogel, the cellulose in the cryogel is not graphitized. Therefore, when the pressure was in a range of less than or equal to 10 MPa, the volume resistivity was in a range of 1.0×10¹ to 1.0×10⁷ Ω·cm.

In the graphs (b) and (c), the cellulose was graphitized by firing the cryogel, and the volume resistivity dramatically decreased. In the graph (b), the volume resistivity was in a range of 5.0×10⁻² to 1.0×10⁰ Ω·cm in a pressure range of less than or equal to 10 MPa, and in the graph (c), the volume resistivity was in a range of 1.0×10⁻³ to 1.0×10⁻¹ Ω·cm in the same pressure range.

Note that when a large load of a pressure more than or equal to 10 MPa is applied, the volume resistivity became substantially constant and substantially saturated in any of the graphs (a) to (c). This is considered to be because pores in the conductive porous material were crushed.

Therefore, by measuring a range of the volume resistivity in a range of less than or equal to 10 MPa in which the volume resistivity fluctuates depending on the pressure, the range of the volume resistivity of the conductive porous material to be measured can be roughly known.

The conductive porous material according to an aspect of the present invention can be said to have conductivity suitable for an electrode material as long as the volume resistivity measured under pressure in the range of less than or equal to 10 MPa (that is, 0 MPa (unpressurized) to 10 MPa) is in a range of 1.0×10⁻³ to 1.0×10⁰ Ω·cm.

In the skeleton structure, it is preferable that more than or equal to 80 atom % of the entire skeleton structure is carbon atoms, and a conductive porous material having high conductivity is obtained. The types and constituent ratios of elements constituting the skeleton structure can be known by elemental analysis (EA). For the elemental analysis, there are known a combustion method (destructive analysis) for determining a ratio of carbon, hydrogen, nitrogen, and the like contained in a sample by evaluating an amount of water, carbon dioxide, nitrogen dioxide, and the like generated by completely combusting the sample, X-ray photoelectron spectroscopy (XPS, non-destructive analysis) for analyzing the type and chemical bonding state of elements constituting a surface by irradiating the surface of the sample with X-rays and measuring the kinetic energy of photoelectrons emitted from the surface of the sample, and the like, and it is possible to calculate a ratio of carbon atoms of a skeleton structure by using such a method.

The skeleton structure preferably includes a fired body obtained by firing one or more fibrous carbon sources selected from the group consisting of cellulose, chitin, chitosan, lignin, and tannin. By combining the above-described radioactive carbon 14° C. measurement, elemental analysis, and morphological information using an optical microscope, an electron microscope, and the like, it is possible to specify the type of fibrous carbon source in addition to whether it is biologically derived or not.

### (Pore Characteristics of Conductive Porous Material)

A specific surface area of the conductive porous material is preferably 40 to 3000 m²/g, and more preferably 100 to 3000 m²/g.

The specific surface area of the conductive porous material is determined by N₂ gas adsorption measurement based on JIS Z 8830:2013. Specifically, BET plot analysis on a desorption side of an N₂ gas adsorption/desorption isotherm is performed to calculate an amount of N₂ gas (=specific surface area) required for forming a monolayer.

An average pore size distribution of the conductive porous material is preferably mesopores (2 to 200 nm), but the conductive porous material may have macropores of more than 200 nm.

The average pore size distribution of the conductive porous material is also determined by the N₂ gas adsorption measurement based on JIS Z 8830:2013, and specifically, calculated from BJH analysis of the N₂ gas adsorption/desorption isotherm.

### (Bulk Density of Conductive Porous Material)

A bulk density of the conductive porous material is preferably in a range of 50 to 500 kg/m³ in a bulk state.

When the bulk density of the conductive porous material is more than or equal to 50 kg/m³, a continuous coating film having sufficient mechanical strength is obtained. When the bulk density is less than or equal to 500 kg/m³, since a space volume of the material is sufficiently contained, the specific surface area is large, the number of adsorbed ions is relatively large, and the electrical capacity is large.

Note that the bulk density of the conductive porous material in a bulk state is generally different from a bulk density of the conductive porous material of another aspect (for example, in a state where the film electrode is formed by pulverization, coating, and drying). The bulk density can be measured according to JIS Z 2504:2020 (apparent density) or JIS Z 2512:2012 (tapped density).

The skeleton structure containing a fibrous carbonaceous material has a spider web-like three-dimensional mesh structure. In the conductive porous material, graphene is uniformly stretched over the entire skeleton structure, and the graphene and the fibrous carbonaceous material are precisely combined. Since graphene is held by the skeleton structure, aggregation of graphene with each other is suppressed.

### <Electrode Containing Conductive Porous Material>

An electrode according to the present exemplary embodiment contains the above-described conductive porous material.

The conductive porous material according to the exemplary embodiment is a composite of a spider web-like skeleton structure containing a fibrous carbonaceous material and graphene that is not aggregated, and has a large specific surface area. Therefore, the conductive porous of the present invention is suitable for use in a wide range of applications, for example, electrodes of power storage devices such as a lithium ion secondary battery and an electric double layer capacitor, and power generation devices such as a fuel cell and a solar cell.

### <Method for Producing Conductive Porous Material>

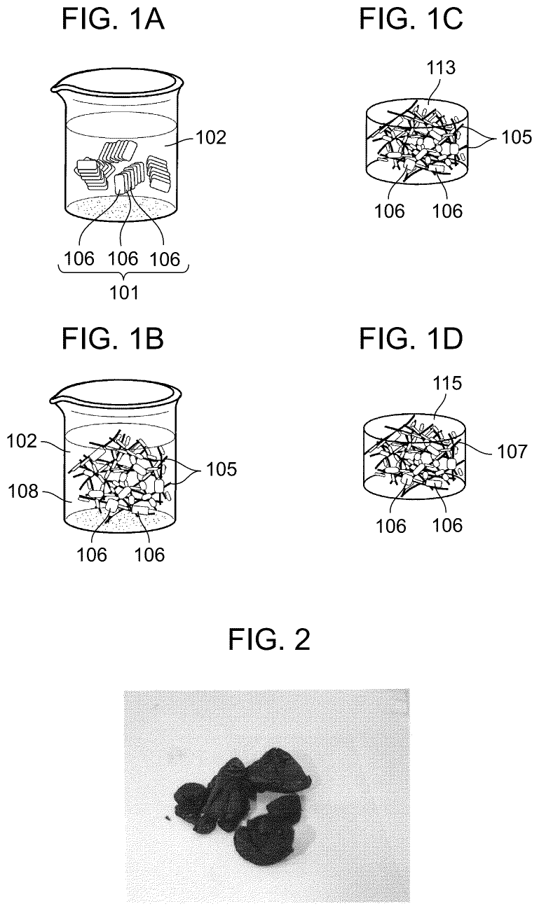

A method for producing conductive porous material 115 of the present exemplary embodiment will be described with reference to FIGS. 1A to 1D. The method for producing conductive porous material 115 includes steps (1) to (3).

### (1) Step of Preparing Dispersion Liquid 108:

Dispersion medium 102, graphene source 101, and fibrous carbon source 105 of biological origin are mixed, and external energy is applied to prepare dispersion liquid 108 containing dispersion medium 102, graphene 106, and fibrous carbon source 105.

### (2) Creation Step of Composite 113:

Dispersion medium 102 is removed from dispersion liquid 108 to create composite 113 containing graphene 106 and fibrous carbon source 105.

### (3) Firing Step of Composite 113:

Composite 113 is fired to obtain conductive porous material 115 containing skeleton structure 107 containing the fibrous carbonaceous material of biological origin and graphene 106 held by skeleton structure 107.

Each step will be described in detail below.

### (1) Step of Preparing Dispersion Liquid 108:

FIG. 1A is a schematic diagram illustrating a state in which graphene source 101 is placed in dispersion medium 102. Graphene source 101 includes a plurality of graphenes 106. Inside graphene source 101, the plurality of graphenes 106 is aggregated, for example, in a state of being layered on each other. In a state in which fibrous carbon source 105 is not included as illustrated in FIG. 1A, even if graphenes 106 are forcibly exfoliated, dispersibility of graphenes 106 in dispersion medium 102 is poor. Therefore, when graphenes 106 are left, the graphenes are re-aggregated and precipitated in dispersion medium 102.

Moreover, even when an attempt is made to prepare a dispersion liquid from graphite as graphene source 101 and water as dispersion medium 102, since the hydrophobicity of the graphite is strong, the graphite and the water are not mixed well, and the exfoliation of the graphite itself does not efficiently proceed.

On the other hand, in step (1), as illustrated in FIG. 1B, dispersion medium 102, graphene source 101, and fibrous carbon sources 105 of biological origin are mixed, and external energy is applied to the mixture. As a result, graphene source 101 is physically exfoliated and separated into the plurality of graphenes 106. Since graphenes 106 adhere to fibrous carbon sources 105, re-aggregation is inhibited. This mechanism is presumed to be because graphenes 106 are combined at a molecular level by electrostatically interacting with negatively charged fibrous carbon sources 105. In dispersion liquid 108, since graphenes 106 can maintain a dispersed state, it can be said that dispersion liquid 108 is excellent in dispersibility. This dispersion liquid exhibits high dispersibility, and the graphenes do not precipitate even when the dispersion liquid is left to stand for a long time.

Fibrous carbon sources 105 of biological origin are a biologically derived resource capable of holding graphenes 106 in a dispersed state, and thus may be referred to as a “biomass dispersant”.

Although a mixing order of dispersion medium 102, graphene source 101, and fibrous carbon sources 105 of biological origin is arbitrary, for example, a fibrous carbon source slurry obtained by mixing a small amount of dispersion medium 102 with fibrous carbon sources 105 and a graphene source mixed solution obtained by mixing remaining dispersion medium 102 with graphene source 101 may be separately prepared, and the fibrous carbon source slurry may be added to the graphene source mixed solution.

As a device for applying the external energy, water jet, microwave, ultrasonic wave, or the like is suitable. As the water jet, chambers having various shapes such as a ball collision chamber, an oblique collision chamber, and a single nozzle chamber can be appropriately used, and for example, the process may be performed at a high pressure of 100 to 245 MPa, preferably 200 to 245 MPa. The number of times of process may be 1 to 20 times, preferably 5 to 10 times.

Since graphene source 101 is physically exfoliated to form graphenes 106 by applying the external energy, the process of applying external energy may be referred to as an “exfoliation process”.

In this way, dispersion liquid 108 (graphene-biomass dispersion liquid) containing dispersion medium 102, graphenes 106, and fibrous carbon sources 105 is prepared.

As dispersion medium 102, a known dispersion medium such as an organic solvent or an ionic liquid can be used, but it is preferable to use water as the dispersion medium from the viewpoint of economic efficiency, environmental compatibility, and ensuring safety.

Graphene source 101 may be a raw material that generates graphenes 106 by delamination. As graphene source 101, one or more selected from the group consisting of artificial graphite, natural graphite, and multilayered graphene are suitable. The shape and form of graphite (artificial graphite and natural graphite) are not particularly limited, and known graphite such as flake graphite, scale-like graphite, earthy graphite, expanded graphite, and spherical graphite can be used.

Note that, in a case where the water jet is used as the external energy, it is preferable to use graphene source 101 having a filler diameter smaller than a pipe diameter of the water jet from the viewpoint of preventing clogging of a pipe. For example, in a case where the pipe diameter is 100 μm, the filler diameter of graphene source 101 is preferably less than or equal to 50 μm.

As fibrous carbon sources (biomass dispersant) 105 of biological origin, a substance having a polymerization degree of 200 to 800 and including a hydroxyl group on the surface is preferable. Moreover, a substance capable of constituting skeleton structure 107 having carbon atoms more than or equal to 80 atom % after firing in step (c) is preferable. Specifically, fibrous carbon sources 105 are preferably one or more selected from the group consisting of cellulose, chitin, chitosan, lignin, and tannin.

Since fibrous carbon sources 105 trap separated graphenes 106 to suppress re-aggregation, the specific surface area of each of fibrous carbon sources 105 is preferably large. From the viewpoint of increasing the specific surface area, a primary fiber diameter of fibrous carbon source 105 is preferably less than or equal to 100 nm. A fiber length of fibrous carbon source 105 can be appropriately used from a short fiber length (for example, 1 μm) to an extra-long fiber length (for example, 50 μm).

### (2) Creation Step of Composite 113:

Dispersion medium 102 is removed from dispersion liquid 108 prepared in step (1) (that is, dried) to obtain composite 113 (graphene-biomass composite) containing graphenes 106 and fibrous carbon source (biomass dispersant) 105. Graphene-biomass composite 113 may be in a state in which graphenes 106 are uniformly stretched around a spider web-like three-dimensional structure constituted by fibrous carbon source 105.

Note that composite 113 may be in a gel state, and composite 113 in that state may be referred to as a “graphene-biomass composite gel”.

As a method for removing dispersion medium 102, a known drying method such as a supercritical drying method, a freeze drying method, a normal pressure drying method, or a vacuum drying method can be used. In view of productivity and economic efficiency, freeze drying is preferable. The freeze drying can suppress shrinkage due to capillary force when removing and drying dispersion medium 102 from dispersion liquid 108. Therefore, it is possible to easily form graphene-biomass composite 113 in a state in which graphenes 106 are uniformly stretched around the spider web-like three-dimensional structure constituted by fibrous carbon source 105.

By the freeze drying, a cryogel (graphene-biomass composite gel 113) is obtained from dispersion medium 102. The freeze drying may be performed, for example, at −50° C. to 0° C., preferably at −50° C. to −20° C., under a reduced pressure of less than or equal to 100 Pa, more preferably less than or equal to 1 Pa.

### (3) Firing Step of Composite 113:

Composite 113 is fired to obtain conductive porous material 115. An object of this step is to burn off a heterologous element (hydrogen, oxygen, nitrogen, and the like) other than carbon contained in fibrous carbon source (biomass dispersant) 105 of biological origin to promote the reconstruction and graphitization (aromatization) of the carbon skeleton. Fibrous carbon source 105 is fired at a high temperature to be formed into a carbon fiber, whereby conductivity is developed in spider web-like skeleton structure 107.

The firing may be performed under an inert gas atmosphere at a firing temperature of 2000 to 2700° C., preferably 2500 to 2700° C. The firing time may be 1 to 300 minutes, preferably 60 to 240 minutes. A rate of temperature increase to a firing temperature may be 1 to 20° C./min, preferably 5 to 15° C./min.

### <Blending Amount of Raw Materials>

In a step of preparing dispersion liquid 108 in step (1), in order to obtain dispersion liquid 108 particularly excellent in dispersibility, preferable blending amounts of the respective components will be described.

The blending amount of graphene source 101 is preferably 0.1 to 2.0 parts by weight, and preferably 0.25 to 1.0 parts by weight with respect to a total weight of dispersion liquid 108, and dispersion liquid 108 in which graphenes 106 are uniformly dispersed can be created.

In fibrous carbon source 105 of biological origin, it is preferable that a small amount of dispersion medium 102 is divided, fibrous carbon source 105 is mixed with the dispersion medium to form a slurry, and the fibrous carbon source slurry (biomass dispersant slurry) is added to remaining dispersion medium 102 together with graphene source 101. The blending amount of the fibrous carbon source slurry is adjusted by the concentration of fibrous carbon source 105 in the fibrous carbon source slurry (this may be referred to as “biomass concentration”), and the type and blending amount of graphene source 101. For example, in a case where the biomass concentration of the fibrous carbon source slurry is 2.0%, the amount is 1.0 to 50.0 parts by weight, preferably 5.0 to 30.0 parts by weight, based on the total weight of dispersion liquid 108, and dispersion liquid 108 in which fibrous carbon source 105 is uniformly dispersed can be created.

As an example, in a case where 10 parts by weight of the fibrous carbon source slurry having a biomass concentration of 2.0% is added to a mixed solution of 89 g of the dispersion medium and 1 g of the fibrous carbon source, 0.02 g of fibrous carbon source 105 is present in 100 g of the total weight of dispersion liquid 108. A mass ratio of the graphene source:the fibrous carbon source is 50:1, and the substantial blending amount of fibrous carbon source 105 is very small with respect to the blending amount of graphene source 101.

According to the method for producing a conductive porous material according to the exemplary embodiment of the present invention, by using fibrous carbon source 105 of biological origin, aggregation of graphene in the dispersion liquid can be suppressed without performing the oxidation treatment of graphene. Accordingly, a conductive porous material having a large specific surface area can be produced safely and at a low cost.

### EXAMPLES

The exemplary embodiments of the present invention will be described based on examples. However, the exemplary embodiments of the present invention are not limited to the following examples.

### Example 1

A measurement sample of the conductive porous material was created under the following conditions.
Dispersion medium: water (ultrapure water)
Graphene source: artificial graphite having a filler diameter of less than 20 μm (manufactured by Panasonic Corporation, PGF)
Fibrous carbon source of biological origin: cellulose nanofibers (manufactured by Sugino Machine Limited, WF₀-10002)

The cellulose nanofibers were prepared in advance into a slurry having a biomass concentration of 2 wt %.

Into a 200 ml lidded bottle, 79 g of weighed water and 1 g of artificial graphite powder were mixed, and 20 g of a slurry of cellulose nanofibers was further added to cover the bottle. Thereafter, the bottle was shaken well by hand, and the water, the artificial graphite, and the slurry in the bottle were stirred to prepare a mixed solution. Next, 100 g of the obtained mixed solution was subjected to an exfoliation process with a water jet (Starburst Mini manufactured by Sugino Machine Limited) (Ball collision chamber, pressure: 245 MPa, number of passes: 10). As a result, a dispersion liquid in which graphenes and cellulose nanofibers were uniformly dispersed was obtained. The exfoliation process was performed for approximately 10 minutes to obtain about 80 g of a graphene-biomass dispersion liquid.

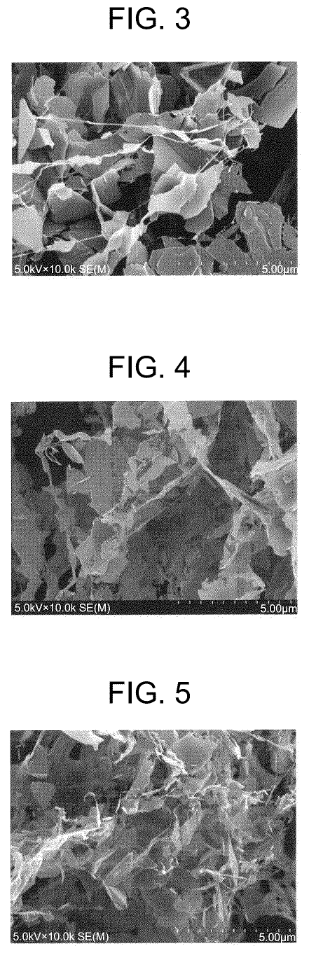

The obtained graphene-biomass dispersion liquid was freeze-dried (−20° C., 100 Pa) to obtain a bulk composite (cryogel). The composite was subjected to a high-temperature treatment (heating rate: 10° C.·min⁻¹, treatment temperature: 2700° C., treatment time: 1 minute) in a firing furnace to obtain a fired body (conductive porous material). FIG. 2 illustrates an appearance photograph of the fired body (conductive porous material) obtained in Example 1, and FIG. 3 illustrates an SEM image of the conductive porous material. As illustrated in FIG. 3, the conductive porous material was a porous material in which the graphene was held in the skeleton structure (a spider web-like three-dimensional mesh structure) of the fibrous carbonaceous material. The graphene was attached to the entire skeleton structure.

### Measurement of Specific Surface Area of Conductive Porous Material

The specific surface area of the conductive porous material was determined by the N₂ gas adsorption measurement in accordance with JIS Z 8830:2013. The specific surface area of the fired body was 99 m²/g, and it was confirmed that the specific surface area was increased 9 times as compared with PGF (specific surface area: 11 m²/g) used as a raw material (graphene source).

### Measurement of Volume Resistivity of Conductive Porous Material

About 1 g of the conductive porous material was weighed with an electronic balance, placed in a cylindrical probe unit of an automatic powder resistance measurement system (MCP-PD600 manufactured by Nitto Seiko Analytech Co., Ltd.), and laid on a bottom surface of the probe unit so that a thickness of the powder sample was uniform to some extent. The probe unit containing the powder sample was set, and the volume resistivity in a thickness direction was measured while automatically applying pressure to the powder sample in the thickness direction. The measurement was performed in a pressure range of 0 MPa (unpressurized) to 63 MPa. The volume resistivity in a range of 0 MPa (unpressurized) to 10 MPa was less than or equal to 1.0×10² Ω·cm.

### Biomass Degree Measurement of Conductive Porous Material by Accelerator Mass Spectrometry (AMS Method)

The sample was combusted, and generated carbon dioxide was hydrogen-reduced with an iron catalyst to create graphite. The graphite was packed in a cathode having an inner diameter of 1 mm with a hand press machine, fitted into a wheel, and attached to an AMS measurement device. Counts of ¹⁴C, ¹³C concentration (¹³C/¹²C), and ¹⁴C concentration (¹⁴C/¹²C) were measured using a ¹⁴C-AMS dedicated instrument (NEC) based on a tandem accelerator. At this time, oxalic acid was used as a standard sample. The biomass degree was calculated using pMC whose measured value was corrected according to ASTM D6866-22. The biomass degree of the conductive porous material was 17 pMC.

FIG. 13 illustrates a relationship between a cellulose nanofiber weight ratio (before firing) of a conductive porous material and a biomass degree of a conductive porous material (fired body). Here, the “weight ratio of cellulose nanofibers” is a weight ratio of cellulose nanofibers in the raw material, and more specifically, a weight ratio of cellulose nanofibers before firing when the total weight of artificial graphite and cellulose nanofibers before firing is 100 wt %.

Note that, for reference, the ¹³C concentrations of artificial graphite (manufactured by Panasonic Corporation, PGF) having a filler diameter of less than 20 μm as the graphene source and cellulose nanofibers (manufactured by Sugino Machine Limited, WF0-10002) as the fibrous carbon source of biological origin were measured by the AMS method to calculate the biomass degrees. Note that, in the measurement, an unfired artificial graphite and an unfired cellulose nanofiber were used. As a result of the measurement, the biomass degree of a petroleum-derived artificial graphite (cellulose nanofiber weight ratio: 0 wt %) was 0 pMC, and the biomass degree of the cellulose nanofiber (cellulose nanofiber weight ratio: 100 wt %) was 100 pMC.

### Example 2

A conductive porous material was created under the same procedure and conditions as in Example 1 except that the blending amount of water was changed to 89 g and the blending amount of the slurry of cellulose nanofibers was changed to 10 g.

FIG. 4 illustrates an SEM image of the conductive porous material. As illustrated in FIG. 4, the conductive porous material was a porous material in which the graphene was held in the skeleton structure (spider web-like three-dimensional mesh structure) of the fibrous carbonaceous material. The graphene was attached to the entire skeleton structure.

The specific surface area, the volume resistivity, and the biomass degree of the conductive porous material were measured in the same procedure as in Example 1.

The specific surface area of the conductive porous material was 105 m²/g, and it was confirmed that the specific surface area was increased about 10 times as compared with PGF (specific surface area: 11 m²/g) used as a raw material (graphene source).

The volume resistivity of the conductive porous material in a range of 0 MPa (unpressurized) to 10 MPa was less than or equal to 1.0×10² Ω·cm.

The biomass degree of the conductive porous material was 9.5 pMC. A result of the biomass degree is illustrated in FIG. 13.

### Example 3

A conductive porous material was created under the same procedure and conditions as in Example 1 except that the graphene source was changed from artificial graphite to natural graphite (CGB-12R manufactured by Nippon Graphite Co., Ltd.).

FIG. 5 illustrates an SEM image of the conductive porous material. As illustrated in FIG. 5, the conductive porous material was a porous material in which the graphene was held in the skeleton structure (spider web-like three-dimensional mesh structure) of the fibrous carbonaceous material. The graphene was attached to the entire skeleton structure.

The specific surface area and the volume resistivity of the conductive porous material were measured in the same procedure as in Example 1.

The specific surface area of the conductive porous material was 99 m²/g, and it was confirmed that the specific surface area was increased about 12 times as compared with CGB-12R (specific surface area: 8 m²/g) used as a raw material (graphene source).

The volume resistivity of the conductive porous material in a range of 0 MPa (unpressurized) to 10 MPa was less than or equal to 1.0×10² Ω2·cm.

### Example 4

A conductive porous material was created under the same procedure and conditions as in Example 1 except that the graphene source was changed from artificial graphite to multilayered graphene (Gi-PW-F031 manufactured by Ishihara Chemical Co., Ltd.).

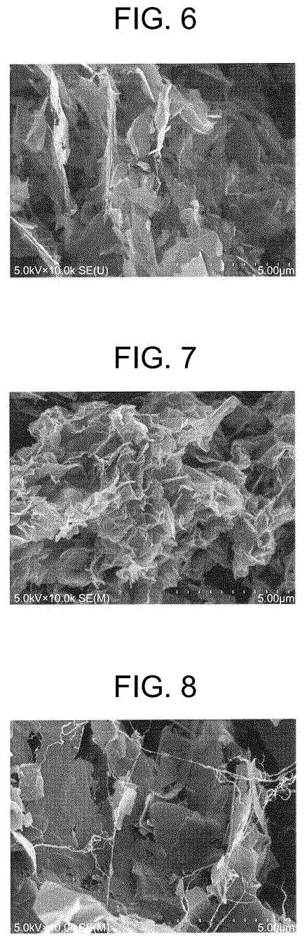

FIG. 6 illustrates an SEM image of the conductive porous material. As illustrated in FIG. 6, the conductive porous material was a porous material in which the graphene was held in the skeleton structure (spider web-like three-dimensional mesh structure) of the fibrous carbonaceous material. The graphene was attached to the entire skeleton structure.

The specific surface area and the volume resistivity of the conductive porous material were measured in the same procedure as in Example 1.

The specific surface area of the conductive porous material was 44 m²/g, and it was confirmed that the specific surface area was increased about 1.5 times as compared with Gi-PW-F031 (specific surface area: 29 m²/g) used as a raw material (graphene source).

The volume resistivity of the conductive porous material in a range of 0 MPa (unpressurized) to 10 MPa was less than or equal to 1.0×10² Ω·cm.

### Example 5

A conductive porous material was created under the same procedure and conditions as in Example 1 except that the graphene source was changed from artificial graphite to monolayer graphene (N002-PDR manufactured by Ishihara Chemical Co., Ltd.).

FIG. 7 illustrates an SEM image of the conductive porous material. As illustrated in FIG. 7, the conductive porous material was a porous material in which the graphene was held in the skeleton structure (spider web-like three-dimensional mesh structure) of the fibrous carbonaceous material. The graphene was attached to the entire skeleton structure.

The specific surface area and the volume resistivity of the conductive porous material were measured in the same procedure as in Example 1.

The specific surface area of the conductive porous material was 278 m²/g, and it was confirmed that a relatively high specific surface area could be maintained although a decrease in specific surface area was observed as compared with N002-PDR (specific surface area: 423 m²/g) used as a raw material (graphene source).

The volume resistivity of the conductive porous material in a range of 0 MPa (unpressurized) to 10 MPa was less than or equal to 1.0×10² Ω·cm.

### Example 6

A conductive porous material was created under the same procedure and conditions as in Example 1 except that the fibrous carbon source of biological origin was changed from cellulose nanofibers to chitin nanofibers (SF⁰-20002 manufactured by Sugino Machine Limited).

FIG. 8 illustrates an SEM image of the conductive porous material. As illustrated in FIG. 8, the conductive porous material was a porous material in which the graphene was held in the skeleton structure (spider web-like three-dimensional mesh structure) of the fibrous carbonaceous material. The graphene was attached to the entire skeleton structure.

The specific surface area and the volume resistivity of the conductive porous material were measured in the same procedure as in Example 1.

The specific surface area of the conductive porous material was 50 m²/g, and it was confirmed that the specific surface area was increased about 5 times as compared with PGF (specific surface area: 11 m²/g) used as a raw material (graphene source).

The volume resistivity of the conductive porous material in a range of 0 MPa (unpressurized) to 10 MPa was less than or equal to 1.0×10⁰ Ω·cm.

### Example 7

A conductive porous material was created under the same procedure and conditions as in Example 1 except that the fibrous carbon source of biological origin was changed from cellulose nanofibers to chitosan nanofibers (EF₀-20002 manufactured by Sugino Machine Limited).

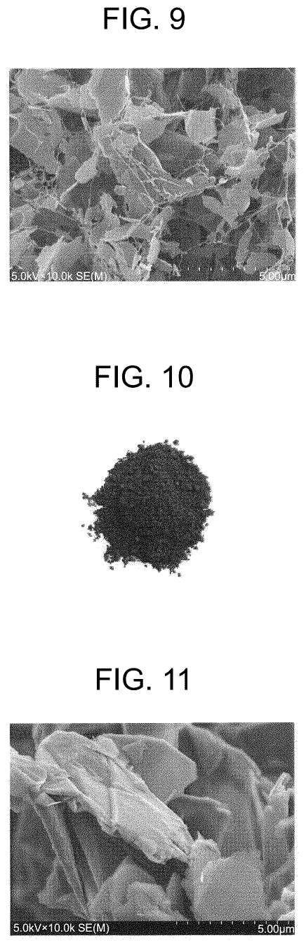

FIG. 9 illustrates an SEM image of the conductive porous material. As illustrated in FIG. 9, the conductive porous material was a porous material in which the graphene was held in the skeleton structure (spider web-like three-dimensional mesh structure) of the fibrous carbonaceous material. The graphene was attached to the entire skeleton structure.

The specific surface area and the volume resistivity of the conductive porous material were measured in the same procedure as in Example 1.

The specific surface area of the conductive porous material was 126 m²/g, and it was confirmed that the specific surface area was increased about 10 times as compared with PGF (specific surface area: 11 m²/g) used as a raw material (graphene source).

The volume resistivity of the conductive porous material in a range of 0 MPa (unpressurized) to 10 MPa was less than or equal to 1.0×10² Ω·cm.

### Comparative Example 1

A graphene-biomass dispersion liquid was obtained under the same procedure and conditions as in Example 1 except that the blending amount of water was changed to 98 g and the blending amount of the slurry of cellulose nanofibers was changed to 1 g.

When the graphene-biomass dispersion liquid was left for 1 day, the graphene precipitated and phase-separated. The precipitated graphene was freeze-dried (−20° C., 100 Pa) to obtain a bulk composite (cryogel). The composite was fired under the same procedure and conditions as in Example 1 to obtain a fired body. FIG. 10 illustrates an appearance photograph of the fired body obtained in Comparative Example 1, and FIG. 11 illustrates an SEM image of the fired body. As illustrated in FIG. 11, no skeleton structure of a fibrous carbonaceous material was formed in the fired body, and the graphenes were in an aggregated state in which the graphenes were stacked on top of one another.

The specific surface area, the volume resistivity, and the biomass degree of the conductive porous material were measured in the same procedure as in Example 1.

The conductive porous material had a specific surface area of 11 m²/g, which was confirmed to be equivalent to PGF (specific surface area: 11 m²/g) used as a raw material (graphene source).

The volume resistivity of the conductive porous material in a range of 0 MPa (unpressurized) to 10 MPa was less than or equal to 1.0×10² Ω·cm.

The biomass degree of the conductive porous material was only 1 pMC. A result of the biomass degree is illustrated in FIG. 13.

From the results of Examples 1 and 2 and Comparative Example 1 in FIG. 13, it can be said that a conductive porous material having a biomass degree of 5 to 55 pMC of the fibrous carbonaceous material of biological origin is preferable.

### INDUSTRIAL APPLICABILITY

According to the method for producing a conductive porous material according to an aspect of the present invention, by using a fibrous carbon source of biological origin, aggregation of graphene in a dispersion liquid can be suppressed without performing an oxidation treatment of a graphene source (graphite or the like), and a dispersion liquid having excellent dispersibility can be obtained. Therefore, the production method of the present invention has high production efficiency of the conductive porous material and high industrial utility value.

By the production method according to an aspect of the present invention, a conductive porous material in which a spider web-like skeleton structure made of carbon fibers and graphene are precisely combined is obtained. Such a conductive porous material is applicable to a wide range of applications, for example, as an electrode material of a power storage device such as a lithium ion secondary battery and an electric double layer capacitor, and a power generation device such as a fuel cell and a solar cell.

### REFERENCE MARKS IN THE DRAWINGS

101 graphene source
102 dispersion medium
105 fibrous carbon source of biological origin
106 graphene
107 skeleton structure of fibrous carbonaceous material of biological origin
108 graphene-biomass dispersion liquid
113 graphene-biomass composite
115 conductive porous material

1. A conductive porous material comprising:
a skeleton structure containing a fibrous carbonaceous material of biological origin; and
graphene held by the skeleton structure,
wherein a volume resistivity of the conductive porous material measured under pressure of less than or equal to 10 MPa is 1.0×10⁻³ to 1.0×100 Ω·cm, and
a biomass degree of the conductive porous material, as measured by accelerator mass spectrometry (AMS) method, is in a range of 5 to 55 pMC.

2. The conductive porous material according to claim 1, wherein the skeleton structure has carbon atoms more than or equal to 80 atom % of an entire skeleton structure.

3. The conductive porous material according to claim 1, wherein the skeleton structure includes a fired body obtained by firing one or more fibrous carbon sources selected from the group consisting of cellulose, chitin, chitosan, lignin, and tannin.

4. An electrode comprising the conductive porous material according to claim 1.

5. A method for producing a conductive porous material according to claim 1, the method comprising:
(1) mixing a dispersion medium, a graphene source, and a fibrous carbon source of biological origin, and applying external energy to prepare a dispersion liquid containing the dispersion medium, graphene, and the fibrous carbon source;
(2) removing the dispersion medium from the dispersion liquid to create a composite containing the graphene and the fibrous carbon source; and
(3) firing the composite to obtain the conductive porous material.

6. The method for producing a conductive porous material according to claim 5,
wherein the fibrous carbon source is one or more selected from the group consisting of cellulose, chitin, chitosan, lignin, and tannin.

7. The method for producing a conductive porous material according to claim 5,
wherein the graphene source is one or more selected from the group consisting of artificial graphite, natural graphite, and multilayered graphene.

8. The method for producing a conductive porous material according to claim 5, wherein the dispersion medium is water.
